(19) United States
(12) Patent Application Publication
(10) Pub. No.: US 2025/0068154 A1
(43) Pub. Date: Feb. 27, 2025

(54) Operator Assistance in An Automation System

(71) Applicant: ABB Schweiz AG, Baden (CH)

(72) Inventors: Saad Azhar, Västerås (SE); Duy Le, Hoa Thanh district, Tay Ninh Province (VN)

(21) Appl. No.: 18/724,279

(22) PCT Filed: Jan. 4, 2022
(86) PCT No.: PCT/EP2022/050049

§ 371 Date: Jun. 26, 2024

(51) Int. Cl. G05B 19/418

(52) U.S. Cl. CPC G05B 19/41885; G05B 2219/31472; G05B 2219/32017

(57) ABSTRACT

An automation system implementing a process flow displayed to an operator through a number of linked graphical objects, a simulation comparing device obtains current status data of the current operation of the automation system including current automation system parameter settings, receives a first simulation selection involving a selection of a simulation with automation system parameter settings that differ from the current automation system parameter settings, receive a second simulation selection involving a selection of another simulation with automation system parameter settings that differ from the current automation system parameter settings and from the automation system parameter settings of the first selection, determines at least one difference in operation for the simulations and displays the at least one difference through manipulating graphical objects corresponding to elements in the process flow that experience the difference in operation.

### TECHNICAL FIELD

The present invention relates to a method, simulation comparing device, computer program and computer program product for assisting an operator of an automation system as well as to an automation system comprising such as simulation comparing device.

### BACKGROUND

Process control is important for ensuring stable production in different automation systems such as mining, oil, chemical processing or power generating systems. Process control might need to rely on simulations, where operators can request the automation system to generate different simulations of the process based on different scenarios to support them in making decisions in managing the process. However, having several simulations with different configurations and outcomes might lead to information overload for operators to assess them quickly and adequately to make appropriate decisions.

WO 2005/109122 discloses a system that can be used for displaying the results of simulations. According to the document the same graphical objects can be used in the design of different visualizations, such as process control and simulation. The graphical objects can for instance be used in a simulation view and an operator view.

However, the consequences of the change in settings can often be hard to assess, because they are not readily apparent from such a simulation. There is also no discussion of how several simulations are to be handled.

There is thus a need for an improvement in the way that simulations are handled in an automation system.

The present invention is concerned with improving the way such simulations are displayed, so that the operator can get a better overview of the consequences of simulations that are being compared with each other.

### SUMMARY

The present invention addresses this situation. The invention therefore aims at solving the problem of simplifying for an operator of an automation system to perform control activities, such as making automation system parameter settings.

This object is according to a first aspect achieved through a method of assisting an operator of an automation system, where the automation system implements a process flow that is displayed to the operator through a number of linked graphical objects representing elements in the process flow, the method being performed by a simulation comparing device and comprising:
obtaining current status data of a current operation of the automation system, the current status data comprising current automation system parameter settings,
receiving a first simulation selection from the operator, which first simulation selection involves a selection of a simulation with automation system parameter settings that differ from the current automation system parameter settings,
receiving a second simulation selection from the operator, which second simulation selection involves a selection of another simulation with automation system parameter settings that differ from the current automation system parameter settings and from the automation system parameter settings of the simulation selected in the first selection,
determining at least one difference in operation for the simulations of the first and the second selection, and
displaying the at least one difference in operation according to a display scheme where graphical objects corresponding to elements in the process flow that experience the difference in operation are manipulated.

The object is according to a second aspect achieved through a simulation comparing device for assisting an operator of an automation system, where the automation system implements a process flow that is displayed to the operator through a number of linked graphical objects representing elements in the process flow, the simulation comparing device being configured to:
obtain current status data of a current operation of the automation system, the current status data comprising current automation system parameter settings,
receive a first simulation selection from the operator, which first simulation selection involves a selection of a simulation with automation system parameter settings that differ from the current automation system parameter settings,
receive a second simulation selection from the operator, which second simulation selection involves a selection of another simulation with automation system parameter settings that differ from the current automation system parameter and from the automation system parameter settings used in the simulation of the first selection,
determine at least one difference in operation for the simulations of the first and the second selection, and
display the at least one difference in operation according to a display scheme where graphical objects corresponding to elements in the process flow that experience the difference in operation are manipulated.

The object is according to a third aspect achieved through an automation system comprising a simulation comparing device according to the second aspect.

The object is according to a fourth aspect achieved through a computer program for assisting an operator of an automation system, where the automation system implements a process flow that is displayed to the operator through a number of linked graphical objects representing elements in the process flow, the computer program comprising computer program code configured to cause a simulation comparing device to, when being loaded into the simulation comparing device:
obtain current status data of a current operation of the automation system, the current status data comprising current automation system parameter settings,
receive a first simulation selection from the operator, which first simulation selection involves a selection of a simulation with automation system parameter settings that differ from the current automation system parameter settings,
receive a second simulation selection from the operator, which second simulation selection involves a selection of another simulation with automation system parameter settings that differ from the current automation system parameter settings and from the automation system parameter settings used in the simulation of the first selection, determine at least one difference in operation for the simulations of the first and the second selection, and
display the at least one difference in operation according to a display scheme where graphical objects corresponding to elements in the process flow that experience the difference in operation are manipulated.

The object is according to a fifth aspect achieved through a computer program product for assisting an operator of an automation system, the computer program product being provided on a data carrier comprising the computer program with computer program code according to the fourth aspect.

The difference in operation may be the difference in operation caused by the use of the differing automation system parameter settings.

The current status data may be obtained when the automation system is operated using the current automation system settings.

The automation system thus comprises automation system parameters and these parameters may be set by operators in order to obtain the automation system parameter settings.

The manipulation may comprise a change in colour. It may additionally or instead comprise a highlighting of the objects.

According to a first variation of the first aspect the method further comprises determining, for each element that experiences a difference in operation, an amount with which the operation differs and the manipulating comprises manipulating the object representing the element to reflect the amount, where the manipulation may involve varying the brightness of the object.

According to a corresponding variation of the second aspect the simulation comparing device is further configured to determine, for each element that experiences a difference in operation, an amount with which the operation differs and when being configured to manipulate graphical objects being configured to manipulate the object representing the element to reflect the amount, where the manipulation may involve varying the brightness of the object.

The elements may comprise paths via which the process flow occurs, which paths may be represented by graphical objects in the form of lines. In this case the difference in operation associated with a path may be displayed through varying the thickness of the line.

The simulations of the first and the second selections may be displayed as selectable thumbnail images in a thumbnail window.

Therefore, the method may additionally comprise displaying, in a thumbnail window, thumbnail images corresponding to a number of available simulations and receiving the first and the second selection as selections of corresponding thumbnail images in the thumbnail window.

In a corresponding fashion the simulation comparing device may be further configured to display, in a thumbnail window, thumbnail images corresponding to a number of available simulations and to receive the first and the second selection as selections of corresponding thumbnail images in the thumbnail window.

Each thumbnail image may comprise representations of automation system elements in the process flow, where the elements that in a corresponding simulation has automation system parameter settings that differ from the current automation system parameter settings are emphasized in the thumbnail image. The emphasis may be made through the use of different colours. The element with different settings may for instance be black and the others may be white.

The simulation comparing device may have placed the thumbnail images in a priority order in the thumbnail window. The order maybe an order according to which the simulation fulfils a key performance indicator criterion. It may for instance be according to which simulation has a highest or lowest key performance indicator value. It may also be a ranking according to safety.

The process may thus have a number of key performance indicators.

In this case the method may further comprise determining the impact of each of the selected simulations on each of the key performance indicators and displaying this impact.

In this case the simulation comparing device may be further configured to determine the impact of each of the selected simulations on each of the key performance indicators and to display this impact.

The impact of a simulation on a key performance indicator may be displayed in relation to an object representing a key performance indicator value of the current operation or in relation to an object representing a key performance indicator value of the simulation. The impact, which can be an increase or a decrease, may be displayed in the object representing the key performance indicator or adjacent the object representing the key performance indicator.

The method may furthermore comprise receiving a first display mode selection from the operator, wherein in the first display mode selection the determining of at least one difference in operation comprises determining a difference in operation between the simulations of the first and the second selection and the displaying of the at least one difference comprises displaying one set of linked objects that is common for the selected simulations, where the display scheme is used in the display of the set of linked objects.

Correspondingly, the simulation comparing device may additionally be configured to receive a first display mode selection from the operator, wherein in the first display mode selection the simulation comparing device when being configured to determine at least one difference in operation is configured to determine a difference in operation between the simulations of the first and the second selection and when being configured to display the at least one difference is configured to display one set of linked objects that is common for the selected simulations, where the display scheme is used in the display of the set of linked objects.

The displaying may in this case also comprise the displaying of linked graphical objects in one process for the simulations of the first and the second selection. There may thus be one displayed process flow used for both simulations.

The method may additionally comprise receiving a second display mode selection from the operator, wherein in the second display mode selection the determining of at least one difference in operation comprises determining a first difference in operation for the simulation of the first selection and determining a second difference in operation for the simulation of the second selection, where the first difference in operation is a difference in operation between the automation system as operated with the current automation system parameter settings and the automation system parameter settings used in the simulation of the first selection and the second difference in operation is a difference in operation between the automation system as operated with the current automation system parameter settings and the automation system parameter settings of the simulation in the second selection, and the displaying of at least one difference comprises displaying the first difference in operation in a first group of graphical objects depicting the process flow using the display scheme and displaying the second difference in operation in a second group of graphical objects depicting the process flow using the display scheme, where the objects in the groups that correspond to each other are displayed together.

The simulation comparing device may thereby be configured to receive a second display mode selection from the operator, wherein in the second display mode selection the determining of at least one difference in operation comprises determining a first difference in operation for the simulation of the first selection and determining a second difference in operation for the simulation of the second selection, where the first difference in operation is a difference in operation between the automation system as operated with the current automation system parameter settings and the automation system parameter settings used in the simulation of the first selection and the second difference in operation is a difference in operation between the automation system as operated with the current automation system parameter settings and the automation system parameter settings of the simulation in the second selection, and the simulation comparing device when being configured to display at least one difference is configured to display the first difference in operation in a first group of graphical objects depicting the process flow using the display scheme and to display the second difference in operation in a second group of graphical objects depicting the process flow using the display scheme and where the objects in the groups that correspond to each other are displayed together.

The objects that correspond to each other may be displayed so that one overlaps the other. They may alternatively be displayed side-by-side near each other.

The present invention has a number of advantages. It allows an operator to compare the consequences of the application of selected simulations in the automation system. The operator can thereby efficiently compare the effects of multiple simulations on the process. He or she may be able to immediately understand the pros and cons of the simulations with regard to being used in the control. Thereby the operator may also be able to select parameter settings to be used in the process in a more effective way.

### BRIEF DESCRIPTION OF THE DRAWINGS

The present invention will in the following be described with reference being made to the accompanying drawings, where

FIG. 1 schematically shows an automation system in the form of a mining system comprising a number of operations,

FIG. 2 schematically shows one realization of a simulation comparing device used in the automation system,

FIG. 3 shows a number of steps being performed by the simulation comparing device in a method of assisting an operator of the automation system,

FIG. 4 schematically shows a first screen being presented to the operator by the simulation comparing device,

FIG. 5 schematically shows a second screen being presented to the operator by the simulation comparing device in which screen the effects of a first and a second simulation on different KPIs is shown,

FIG. 6 schematically shows a third screen being presented to the operator by the simulation comparing device in which a third screen depicting the differences between the second and a third simulation is displayed in a common view,

FIG. 7 schematically shows a fourth screen being presented to the operator by the simulation comparing device, in which screen the second and third simulations are shown together with different values of the KPIs,

FIG. 8 schematically shows a fifth screen being presented to the operator by the simulation comparing device in which screen the second and third simulations are shown together with a trend comparison window where the trends of a KPI in the two simulations are shown, and

FIG. 9 shows a data carrier with computer program code, in the form of a CD-ROM disc, for implementing the machine set point determining device.

### DETAILED DESCRIPTION

In the following, a detailed description of preferred embodiments of an automation system as well as a method, simulation comparing device, computer program and computer program product for assisting an operator of the automation system will be given.

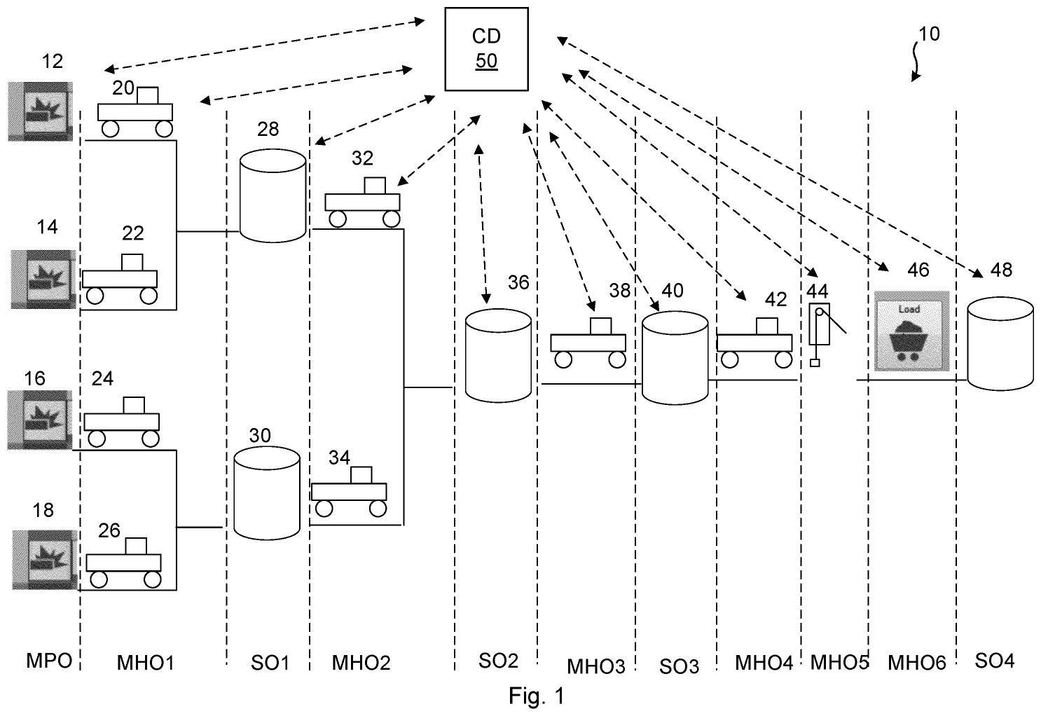

FIG. 1 schematically shows an exemplifying automation system 10, which in this case is a mining system. However, it should be realized that this is merely one example of an automation system in which aspects of the present disclosure may be implemented. Examples of other types of automation systems are systems such as paper and pulp production systems, oil and gas production systems and electrical power generation and transmission systems.

In such a system there may be an operation process flow in which a number of operations are performed. As an example relating to mining, the operations comprise a material production operation MPO, which in the case of mining may be a first ore producing operation that as an example is a blasting operation. In the present example there is a first production point 12, a second production point 14, a third production point 16 and a fourth production point 18, where in the present example the material production operation MPO is carried out at each of the production points 12, 14, 16 and 18.

After the material production operation MPO follows a first material handling operation MHO1 for moving material away from the production points 12, 14, 16 and 18. The first material handling operation MHO1 may be considered to be a first material transporting operation, which may additionally be a first ore transporting operation involving the transporting of ore using equipment such as Load Haul and Dump (LHD) vehicles. In the figure there is a first LHD vehicle 20 moving material away from the first production point 12, a second LHD vehicle 22 moving material away from the second production point 14, a third LHD vehicle 24 moving material away from the third production point 16 and a fourth LHD vehicle 26 moving material away from the fourth production point 18. The first material handling operation MHO1 is followed by a first storing operation SO1, which in this case is a first intermediate material storing operation. This first storing operation SO1 may involve storing the material in material storages, which in this case may be so-called ore passes. There is here a first material storage 28 at a first material storage point and a second material storage 30 at a second material storage point. The material storages 28, 30 and 32 may be connected to the material production points 12, 14, 16 and 18 via a number of paths in the form of at least one road network. In the example in FIG. 1, the first material storage 28 is connected to the first and second production points 12 and 14 via a first road network, while the second material storage 30 is connected to the third and fourth production points 16 and 18 via a number of paths in the form of a second road network. The first and second LHDs 20 and 22 may therefore transport material to the first material storage 28 via the first road network and the third and fourth LHDs 24 and 26 may transport material to the second material storage 30 via the second road network.

After the first storing operation SO1 follows a second material handling operation MHO2 for moving material away from the first and second material storages 28 and 30. The second material handling operation MHO2, which may be a second material transporting operation, also involves the transporting of material using LHD vehicles. In the figure there is a fifth LHD vehicle 32 moving material from the first material storage 28 and a sixth LHD vehicle 34 moving material from the second material storage 14. The second material handling operation MHO2 is followed by a second storing operation SO2, which in this case is a second intermediate material storing operation. This intermediate material storing operation SO2 may also involve storing of the material in material storages, which material storages may likewise be one or more ore passes if the material is ore. There is here a third material storage 36 at a third material storage position. The third material storage 36 may be connected to the first and second material storages 28 and 30 via a number of paths in the form of a third road network. The fifth and sixth LHD vehicles 32 and 34 may thereby transport material to the third material storage 36 of the second storing operation SO2 from any of the material storages 28 and 30.

After the second storing operation SO2 follows a third material handling operation MHO3 for moving material away from the third material storage 36. The third material handling operation MHO3, which may be a third material transporting operation, also involves the transporting of material using LHD vehicles. In the figure there is a seventh LHD vehicle 38 moving material from the third material storage 36.

After the third material handling operation MHO3 follows a third storing operation SO3, which in this case is a third intermediate material storing operation. This intermediate material storing operation SO3 may also involve storing of the material in material storages, which material storages may likewise be one or more ore passes if the material is ore. There is here a fourth material storage 40 at a fourth material storage position. The fourth material storage 40 may be connected to the third material storage 36 via a path or track such as a road. The seventh LHD vehicle 38 may thereby transport material to the fourth material storage 40 of the third storing operation SO2 from the third material storage 36.

After the third storing operation SO3 follows a fourth material handling operation MHO4 for moving material away from the fourth material storage 40, which fourth material handling operation MHO4 may be a fourth material transporting operation involving a transporting using transporting equipment such as trucks, trains, wagons or conveyor belts. In the present example the transporting involves the use of an eighth LHD vehicle 42. Thereafter follows a fifth material handling operation MHO5, which may be a fifth material transporting operation that as an example is a hoisting operation using hoisting equipment 44. A hoisting operation may also be considered to be an ore handling operation. The eighth LHD vehicle 42 may thereby use a path or track, such as a road, between the fourth material storage 40 and the hoisting equipment 44.

After the fifth material handling operation MHO5 follows a sixth material handling operation MHO6 for moving material away from the hoisting equipment 44. This is done using a transportation device 46 that in this case is a wagon that moves along a track in the form of a rail After the sixth material handling operation MHO6 there is a fourth storing operation S04 involving storing material in a fifth material storage 48. The wagon 46 is moved along the path, which path thereby runs between the hoisting equipment 44 and the fifth material storage 48.

There is finally a control device CD 50 which receives measurements from different equipment involved in the automation process and which may also transmit commands to them. Such exchange of signals is made between all the equipment at each of the operations and the control device 50. However, in the first four operations the signals are only shown for the first production point 12 in the material production operation MPO, the first LHD vehicle 20 in the first material handling operation MHO1, the first material storage 28 in the first storing operation SO1 and the fifth LHD vehicle 34 in the second material handling operation MHO2. The control device 50 may be implemented through a so-called Supervisory Control And Data Acquisition (SCADA) device.

It should here be realized that the automation system 10 in FIG. 1 is a mere example and that further or fewer operations may be included. It is also possible with additional types of operations, such as charging, drilling and shotcreting. As mentioned earlier it is also possible that the automation system is another type of automation system than a mining system

The automation system 10 provides an automation or process flow starting at the material production operation MPO and ending with the fourth storing operation SO4. There is thus a production flow from the material production operation MPO to the fourth storing operation SO4.

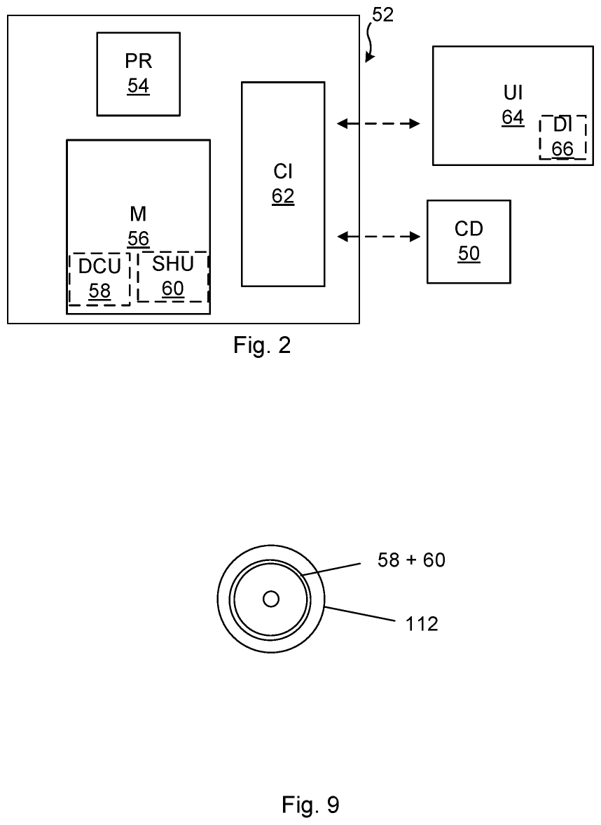

FIG. 2 shows a block schematic of a simulation comparing device 52 used in different aspects of the present disclosure, The simulation comparing device 52 comprises a processor PR 54 and a memory M 56 comprising a displaying control unit DCU 58 and a simulation handling unit SHU 60, which are both provided in the form of computer program code, software code or computer instructions. The processor 54 implements a display control function when running the computer program code of the displaying control unit 58 and performs a simulation handling function when running the computer program code of the simulation handling unit 60.

There is also a communication interface CI 62 that the simulation comparing device 52 uses for communication with a user interface UI 64 as well as with the control device CD 50. The user interface 64, which comprises a display DI 66, is shown as being provided outside of the simulation comparing device 52. However, it should be realized that it may as an alternative be a part of the simulation comparing device 52.

In some variations the user interface 64 is a touch screen via which data can be presented for an operator by the simulation comparing device 52 as well as via which data can be entered by the operator. It should be realized that in other variations the display 66 may only be a display and the inputs provided through a keypad or a keyboard, a trackball, a joystick or some other buttons.

An exemplifying process being controlled by the automation system is the flow of material in a mine, such as the transportation of ore and rock, as a process with different elements like conveyor belts, LHDs (Load, Haul and Dump machine), trucks, and mine hoist.

With the recent advancements of artificial intelligence, simulators can be employed in process control to assist operators in making decision to maintain production processes. In traditional process control, operators either rely on past experiences or employ a try-and-error approach to adjust parameters in the process and wait to see the result of the adjustment. This will be not only time consuming but can also be costly if the parameters were adjusted incorrectly, especially in unprecedented scenarios. With the employment of simulators, the operators can command the system to quickly generate multiple simulations of possible future states of the process based on current data and different configurations of parameters. The operators can assess these simulations to decide the most suitable way to adjust the parameters to achieve desired outcomes. However, multiple simulations simultaneously generated can cause information overload to the operators. For each simulation, the operators may need to memorize which parameters were adjusted and what are the outcomes of those adjustments. As several parameters can be configured in a simulation and each configuration can impact a large number of elements and indicators in the process, it will be mentally demanding and tedious for the operators to keep track of all of these for all simulations by themselves while making decisions. This high cognitive workload can consequently lead to mistakes in the operators' decisions in process control. Thus, it is necessary to have effective approaches to visualize multiple simulations that allow operators to quickly perceive the similarities and differences between them as well as their relative pros and cons.

Aspects disclosed herein introduce visualization of process simulations in a way that helps operators to quickly perceive the particularity of each simulation and identify the similarities and differences among multiple simulated processes. Based on this, operators can quickly derive the pros and cons of different simulated process control scenarios to provide suitable decisions such as to select automation system parameter settings to be used in the process.

According to aspects described herein, a three-step visualization approach may be used to allow an operator to first easily distinguish a simulation from another and then further explore and compare details of multiple simulations to figure out their relative pros and cons. At the first step of visualization, each simulation may be visually represented by a thumbnail image which visually encodes the parameter configuration of the corresponding simulation. This will help the operator to roughly and quickly identify what has been configured in a simulation. At the second step of visualization, the operator can select a thumbnail to further explore the details of the corresponding simulation. A visualization layer may be overlaid on the visualization of the current process, highlighting in details the configured parameters and the resulted changes to the elements that correspond to the equipment and operations of the process. The visualization layer may additionally show key performance indicators (KPIs) of the process if the configuration of the selected simulation is applied to the current process. Furthermore, at the third step, an interface may be offered that allows the operator to visually compare multiple simulations efficiently. The interface provides a visualization emphasizing the process elements that were differently impacted by the simulations as well as offering comparative visualizations of the process KPIs resulted by the selected simulations.

The simulation comparing device 52 is based on modular, object-oriented simulation models of the different entities involved. A top-level controller, the control device 50, is responsible for dynamically invoking the relevant models and serves as a bridge between the user interface 64 and connected systems to retrieve data to be used for simulation parameters.

The simulation comparing device 52 uses a simulation handling function provided by the simulation handling unit 60 and associated visualizations provided by the displaying control unit 58.

The starting point for the operation of the simulation comparing device 52 is the current system settings of an actual current operation of the automation system 10, which involves current parameters of different operations. The operator may then see what impact a simulation having at least one parameter that is different from the currently used parameter settings has on the automation system and the display control unit 58 gives the operator feedback on the anticipated impact of these changes via the user interface 64.

The operator has access to a screen of the current operation of the automation system and can open an existing simulation. When the operator opens an existing simulation, a simulation screen that is based on the current operation screen is presented to the operator by the display control unit 58. In this simulation screen, the simulation unit 60 may indicate which parameter settings are different and the effect of these differing parameter settings has on the process. It may thus indicate the effect, which effect is different than the effect of current parameter settings.

The display control unit 58 keeps tracks of the differences and provides feedback to the operator on the anticipated impact on the overall process and its outcomes. The display control unit 58 may cascade the effects of these differing parameter settings in the connected parts of the process. All of this may be achieved by incorporating individual simulation models for each of the configurable elements in the process within the overall process level simulation.

The simulated state of the process is visualized by indicating which elements in the process are manipulated for the current simulation as well as how the changes of these elements affect the outcome of the process and any connected KPIs (Key Performance Indicators).

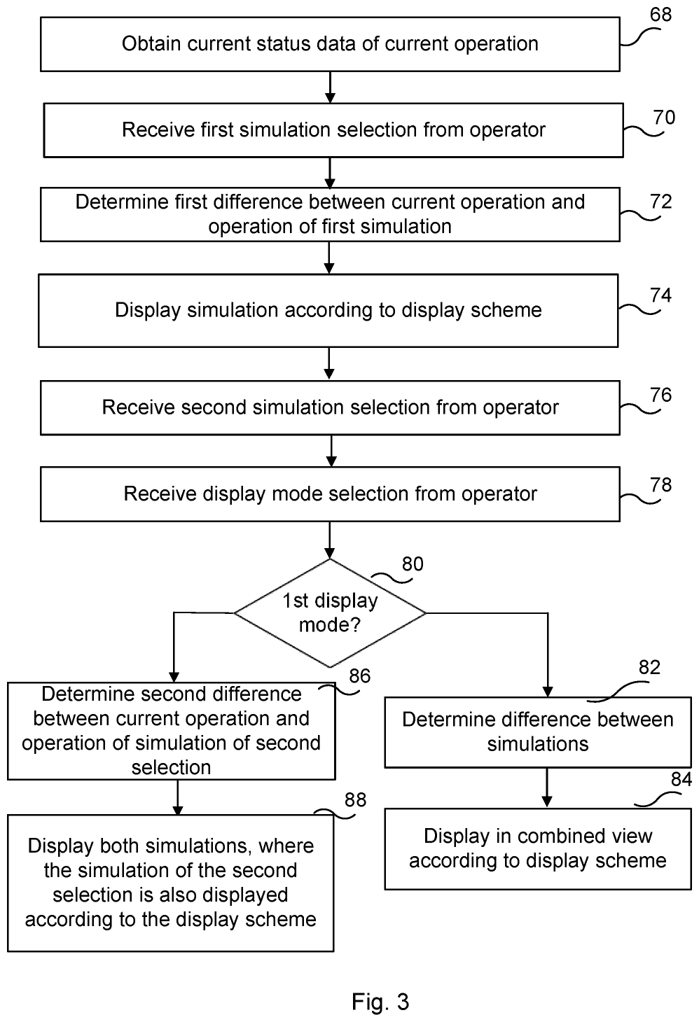

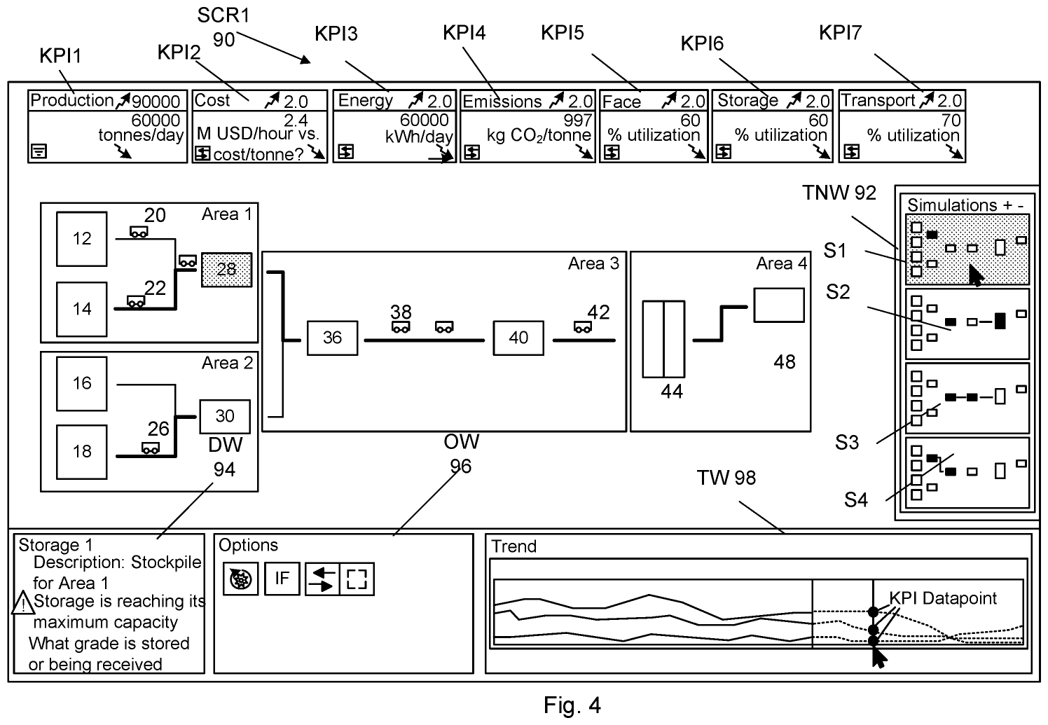

A method of assisting an operator of the automation system will now be described with reference being made to FIG. 3, which shows a number of steps being performed by the simulation comparing device 52 and to FIGS. 4, 5, 6, 7 and 8, which schematically show a first, second, third, fourth and fifth screen being presented to the operator by the simulation comparing device 52. The assisting may in this case be assisting the operator to assess the consequences if automation system parameter settings used in the simulations were to be introduced in the automation system.

The automation system 10 implements a process flow that is displayed to the operator via the user interface 64 by the display control unit 58 through a number of linked graphical objects representing elements (operations, paths, equipment and/or locations) in the process flow.

In operation the control device 50 may control the automation system 10 using current automation parameter settings. In the context of the mining system of FIG. 1, such current automation system parameter settings may comprise settings of automation system parameters such as the amount of blasting to be made, the time intervals between blasting, how many pieces of transporting equipment that are to be used, to which degree they are to be filled with material, the speed with which they are to be moved and the minimum and maximum levels of material in the material storages. These parameters are thus parameters that can be set by the operator in order to control the process flow.

The simulation comparing device 52 may obtain current status data of the actual current operation of the automation system from the control device, step 68, where current status data comprises the automation system parameters that are used on the control of the process. The current status data thereby comprises current automation system parameter settings. Furthermore, the current status data comprises data defining the current status of the operation or process being run by the automation system 10.

Aspects of the present disclosure allow the operator to visually preview or compare different simulated scenarios to make more informed decisions in controlling a process. More specifically, the simulation comparing device 52 may employ a three-level visualization approach that allows operators to efficiently identify, explore and compare different simulations to assist them in making decisions.

The display control unit 58 may display thumbnail images of simulations that can be selected. The display of the thumbnails may be done in a thumbnail window, where each thumbnail image may comprise representations of the automation system elements in the process flow and where the elements that in a corresponding simulation has automation system parameter settings that differ from the current automation system parameter settings are emphasized in the thumbnail image. The elements that have been changed in a simulation in relation to the current operational settings are thus emphasized in the corresponding thumbnail image. The emphasis may be made through the use of different colors. The element with different settings may for instance be black and the others may be white,

It is here possible that the thumbnail images are placed in a priority order in the thumbnail window, which priority order may be an order according to a key performance indicator of the automation system. The order may be the order according to which the simulation fulfils a key performance indicator criterion. It may for instance be according to which simulation has a highest or lowest key performance indicator value. The order may also be a ranking according to some other criterion, such as safety.

FIG. 4 schematically shows an exemplifying first screen SCR1 90 displayed to an operator. Originally the first screen 90 shows a visualization of the current process (in the middle of the interface) with, the process' KPIs (top) and a list of thumbnail images (on the right side) in a thumbnail window TNW 92, which thumbnail images represent different generated simulations.

As can be seen in FIG. 4, the process is shown through elements representing the production points 12, 14, 16 and 18, the first, second and fourth LHD vehicles 20, 22 and 26, the first and second material storages 28 and 30, the third material storage 36, the seventh LHD vehicle 38, the fourth material storage 40, the eighth LHD vehicle 42, the hoisting equipment 44 and the fifth material storage 48, with the elements representing storages, production points and hoisting equipment being linked by elements representing road networks and tracks used for transportation.

Furthermore, KPIs are being shown through a first KPI widget KPI1, a second KPI widget KPI2, a third KPI widget KPI3, a fourth KPI widget KPI4, a fifth KPI widget KPI5, a sixth KPI widget KPI6 and a seventh KPI widget KPI7. In the view the first KPI may be the production at the production points, the second KPI may be cost of the production, the third KPI may the energy consumed by the process, the fourth KPI may be emissions from the process, the fifth KPI may be utilization (FACE) of the production equipment, the sixth KPI may be the utilization of the storages and the seventh KPI may be the utilization of transporting equipment.

Each simulation is thereby represented as a thumbnail image in a thumbnail window. The thumbnail images may be selected by the operator. They are therefore also selectable.

Therefore, the display control unit 58 may additionally display thumbnail images corresponding to a number of available simulations in a thumbnail window. Each thumbnail may additionally show a simplified structure of the process.

As an example shown in FIG. 4, there is a first simulation S1, a second simulation S2, a third simulation S3 and a fourth simulation S4 in the thumbnail window TNW 92, where in the shown view, the first simulation S1 appears at the top of the window 92 and then follows the second, third and fourth simulations S2, S3 and S4. Each thumbnail image visually encodes certain particularities of its corresponding simulation so that it can be easily differentiated from another. One way to create such thumbnail is to display a simplified visual structure of the process and utilize colors to highlight the process elements that were configured in the simulation. It is for instance possible that the elements that were configured for the corresponding simulation are marked, such as being highlighted as black, with the other elements having another colour such as white or grey.

In the given example, the production points 12, 14, 16 and 18, the material storages 28, 30, 36, 40 and 48 and the hoisting equipment 44 are shown in each thumbnail, where the elements that have received different parameter settings compared with the current operation are marked through being black. It can be seen that in the first simulation S1, the first material storage 28 has received new parameter settings, in the second simulation S2 the fourth material storage 40 and the hoisting equipment 44 have received new parameter settings, in the third simulation S3 the third and the fourth material storages 36 and 40 have received new parameter settings and in the fourth simulation S4, the first and the third material storages 28 and 36 have received new parameter settings.

This approach helps operators quickly identify where and even what in the process were configured for the simulation. It is even possible to use different shades of a color to indicate the amount of changes in the configurations (for example. if a parameter of an element was changed 20%, the element shown in the thumbnail may be less dark than in a simulation where the element was changed 50%). This visualization approach should let operators have rough ideas of what has been done for each simulation just by browsing through the list of thumbnails.

When the operator is viewing the first screen 90, the simulation handling unit 60 may receive a first simulation selection from the operator, step 70, which is a selection of an existing simulation that comprises automation system parameter settings that differ from the current automation system parameter settings. It is thereby evident that at least one automation system parameter has a setting in the selected simulation that differs from the setting of the parameter in the current operation. When thumbnails are used, it is also possible that the first simulation selection is received as a selection of a corresponding thumbnail image.

The simulation handling unit 60 furthermore determines at least one difference in operation for selected simulations, while the display control unit displays the at least one difference through manipulating graphical objects corresponding to elements in the process flow that experience the difference in operation.

In this case, the simulation handling unit 60 may determine a first difference in the operation of the automation system 10 between the actual current operation according to the current system settings and the simulation of the first selection, step 72. This is the effect of the different parameter settings on the operation of the automation system, i.e. the effect it has on the process. It is thus a determination of the effect on the automation system by the use of the differing automation system parameter settings in the simulation.

Information about the first difference is then provided to the displaying control unit 58, which goes on and displays at least difference and in this case the first difference according to a display scheme, step 74. In this display scheme the graphical objects in the process flow representing elements that experience the at least one difference are manipulated, where the at least one difference in this case is the first difference. The difference in operation for a graphical object may then be obtained through detecting a change in the status data of a piece of equipment corresponding to or using the element that the graphical object depicts. The manipulation may comprise a change in colour. It may additionally or instead comprise a highlighting of the objects. Thereby the operator is allowed to determine the consequences of the parameter settings used in the simulation selected in the first selection.

As is indicated above, the simulation of the first selection may have at least one automation system parameter setting for an operation and/or location in the process flow that differs from a corresponding parameter in the current operation and the difference in operation may comprise a difference in operation downstream of the operation and/or location with the at least one parameter setting.

In this way the operator can, when browsing the list of thumbnails, identify a simulation related to a certain configuration of interest, and select the corresponding thumbnail and the simulation's details will be visualized on top of the current visualization of the process.

More specifically, another layer of visualization may be overlaid on top of the visualization of the current process emphasizing the elements that were configured and the changes to the process' elements and KPIs resulted by the simulation, see FIG. 4. The operator may thereby compare a simulation option with the current state of the process in order to coarsely determine if the configuration approach of this simulation might fit their need. In the example of FIG. 4 the operator has selected the first simulation S1 and therefore the element that has received new parameter settings, which in this example is the first material storage 28, is highlighted or shown with a different colour than the other elements in the process view. The effects of this change backwards and forwards, i.e. upstream and downstream, in the process is also indicated. In the example, this may be done through using a different color of the paths used in the first, second, third, fourth and sixth material handling operations. In case there is an increase in the amount of material transported the lines may get thicker, while a lowering of the amount may be indicated with thinner lines representing the paths.

The elements may thus comprise paths such as roads, tracks and conveyor belts via which the process flow occurs and these paths may be represented by graphical objects in the form of lines. In this case the difference in operation associated with a path may be displayed through varying the thickness of the line as well a the use of colour.

Also, the effects of the simulation on the KPIs may be indicated such as if they are increased or decreased.

The simulation handling unit 60 may therefore determine the impact of each of the selected simulations on each of the key performance indicators and the displaying control unit 58 may display this impact.

The impact of a simulation on a key performance indicator may be displayed in relation to an object representing a key performance indicator value of the current operation in this case the simulation comparing device may be further configured to determine the impact of each of the selected simulations on each of the key performance indicators and to display this impact.

The impact of a simulation on a key performance indicator may be displayed in relation to an object, here widget, representing a key performance indicator value of the current operation or in relation to an object representing a key performance indicator value of the simulation. The impact, which can be an increase or a decrease, may be displayed in the object representing the key performance indicator or adjacent the object representing the key performance indicator.

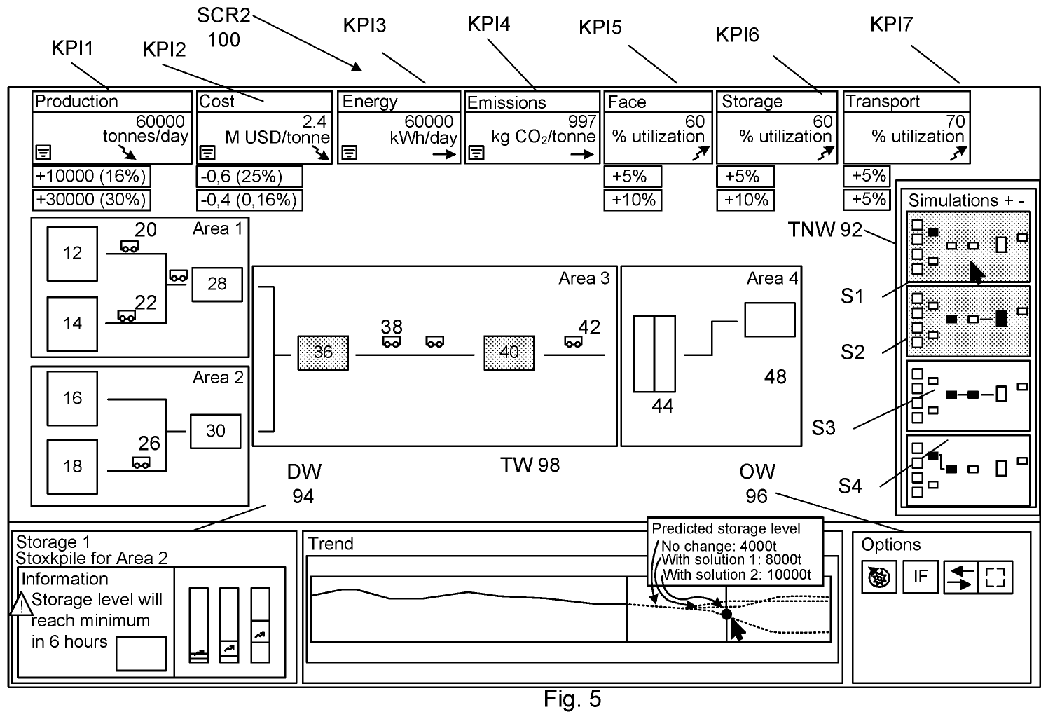

In the example in FIG. 5 visualization overlays (e.g. trend arrows) are used on the KPI widgets to indicate how the simulation affected the KPIs of the current process (e.g. increased, decreased or remained the same).

It may then also be possible for the operator to look at more details of the element with new parameter settings in a details window DW 94, to make optional selections in an options window, OW 96, as well as to look at trends of one or more of the KPIs in a trend window TW 98.

The simulation handling unit 60 may additionally determine if the difference in operation and/or status leads to a risk threshold being crossed and the operator may be warned in case there is such a crossing. This may be done through the display control unit 58 displaying such warnings, where the warning may be linked to the elements of the automation system where the threshold is crossed. The risk threshold may thereby be linked to an operation or location in the automation system and the warning may be made in relation to the graphical object representing the operation or location.

It is additionally possible that the displaying of the difference is only made if the difference in the operation between the automation system as operated with the current automation system settings and the automation system settings used in the simulation cross a difference threshold. The operator may in this case also be allowed to set the difference threshold.

The operator can in this way closely investigate the effect of the first selected simulation on the operation of the automation system and may additionally investigate also the other simulations in the same way.

According to aspects of the present disclosure, the operator may additionally make a second simulation selection for comparison with the simulation of the first selection. When thumbnails are used, it is possible that also the second simulation selection is received as a selection of a corresponding thumbnail image.

Thereby, after possibly browsing through several simulations, the operator might need to put together some simulation options of interest to compare their impacts on the process in order to find the most suitable one. The simulation comparing device 52 provides an interface to support such comparison efficiently. The interface enhances the visualization of the current process with the changes caused by the selected simulations.

The simulation handling unit 60 may therefore receive a second simulation selection from the operator, which simulation selection involves a selection of another simulation with automation system parameter settings that differ from the automation system parameter settings used in the current operation and from the automation system parameter settings used in the first selected simulation, step 76.

For instance, if the operator selected the first simulation S1 in the first selection and the second simulation S2 in the second selection in order to compare the first and the second simulations S1 and S2, then it is possible to see the effect on the KPIs that each simulation has. The process KPIs may be augmented by visualizations indicating the changes each simulation has on the process (for example, addition bars with varied lengths indicating different amounts of changes). In the example of FIG. 5, the operator has selected to compare the first and the second simulations S1 and S2 and has more particularly selected to view the effects of these simulations on the KPIs. It can be seen that they have had different influences on the first, second, fifth, sixth and seventh KPIs KPI1, KPI2, KPI5, KPI6 and KPI7, while the third and fourth KPIs KPI3 and KPI4 are unaffected by both simulations.

As was mentioned earlier, the simulation handling unit 60 may determine a difference in operation for the simulation of the first selection and the simulation of the second selection, where the difference in operation may differ based on if the operator has selected a first or a second display mode. The simulation handling unit 60 may thus receive a display mode selection from the operator.

If the operator has selected the first display mode, step 80, the determining of at least one difference in operation may comprise a determining of a difference in operation between the simulation that was selected in the first selection and the simulation that was selected in the second selection, step 82. Thereafter the display control unit 58 controls the user interface to display the process control elements of the process, in a combined view according to the display scheme, step 84. The display is the display of one set of linked objects that is common for the selected simulations. The displaying may thereby be the displaying of linked graphical objects in one process for the simulations of the first and the second selection. There may thus be one displayed process flow used for both simulations. In the combined view the difference is displayed using the display scheme, i.e. through manipulating graphical objects corresponding to elements in the process flow that experience the difference in operation. The difference may thus be displayed through manipulating graphical objects representing elements that are affected differently by the simulations of the first and the second selection, for instance through being emphasized or highlighted or through the use of different colours.

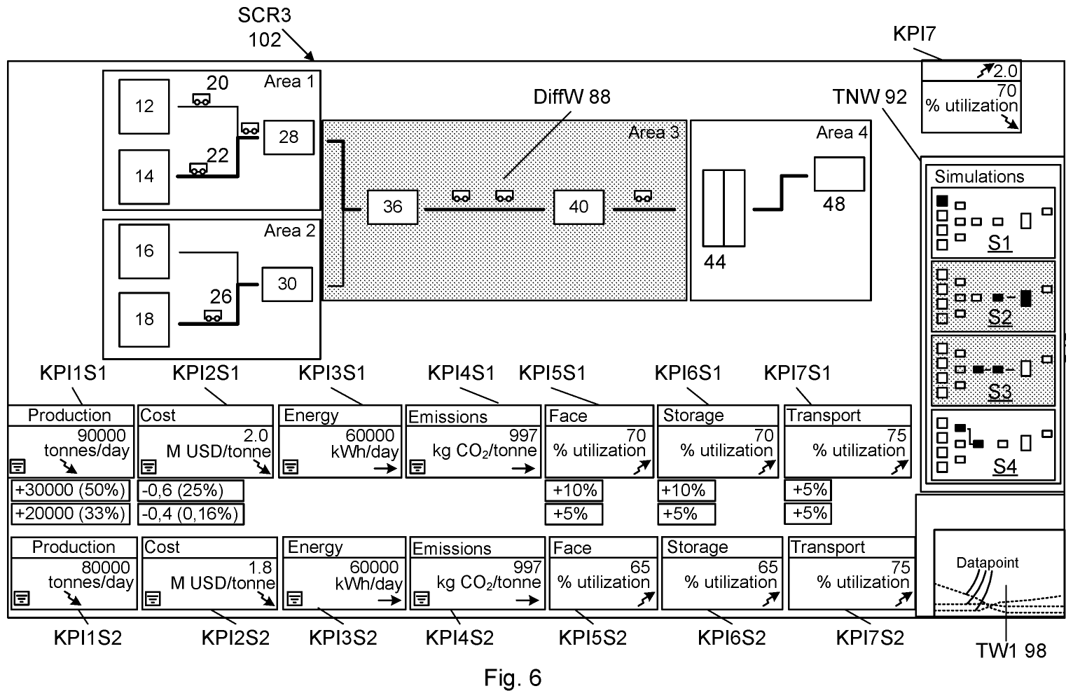

The changes to be visualized may include the ones on the process elements and the ones on the process KPIs. For the changes on the process elements, to avoid cluttered visualization, which might lead to information overload, an approach to consider is only highlighting the components where there are differences in the impacts of the selected simulations. When a plurality of simulations are selected, the visualization of the current process may be augmented by visual enhancements emphasizing the elements differently affected by the simulations. This is schematically shown in FIG. 6, where a difference window DiffW 88 shows the elements that are differently impacted.

In the example of FIG. 6, the operator has selected to compare the second and third simulations S2 and S3 and the elements that have new parameter settings in both simulations may be highlighted as well as any elements that interconnect them. The first selection may in this case thus be the selection of the second simulation S2 and the second selection may be the selection of the third simulation S3, or vice versa.

The elements that are differently affected may be colorized, where the shade of the color can also be used to encode the differences in the changes caused by different simulations. For example, at an element, if the difference among the changes caused by the simulation is 10%, its highlighting color shade can be less bright than if the difference is 50%. This will help operators easily focus on how the process elements can be differently affected by different control approaches.

The simulation handling unit may thereby determine, for each element that experiences a difference in operation, an amount with which the operation differs and in this case the previously described manipulating may comprises manipulating the object representing the element to reflect the amount, where the manipulation may involve varying the brightness of the object.

On the other hand, if the operator has selected the second display mode, step 80, then the simulation handling unit 60 determines a second difference in operation for the simulation of the second selection, step 86, where the second difference in operation is a difference in operation between the automation system as operated with the current automation system parameter settings and the automation system parameter settings used in the simulation of the second selection.

Thereafter the display control unit 58 continues to display the first difference in operation according to the displaying scheme for the simulation of the first selection as well as starts to display the second difference in operation associated with the simulation of the second selection, step 88, which displaying of the second difference is also made using the displaying scheme through manipulating graphical objects corresponding to elements in the process flow that experience the second difference in operation. It More particularly, the at least one difference is displayed through displaying the first difference in operation in a first group of graphical objects depicting the process flow and through displaying the second difference in operation in a second group of graphical objects depicting the process flow. The objects in the groups that correspond to each other are also displayed together.

The objects that correspond to each other may be displayed so that one overlaps the other. They may alternatively be displayed side-by-side near each other.

The displaying of the simulations of the first and the second selection may thus be made side-by-side or partly overlapping. The manipulation being made may also here comprise a change in colour and/or highlighting as well as in shading or brightness.

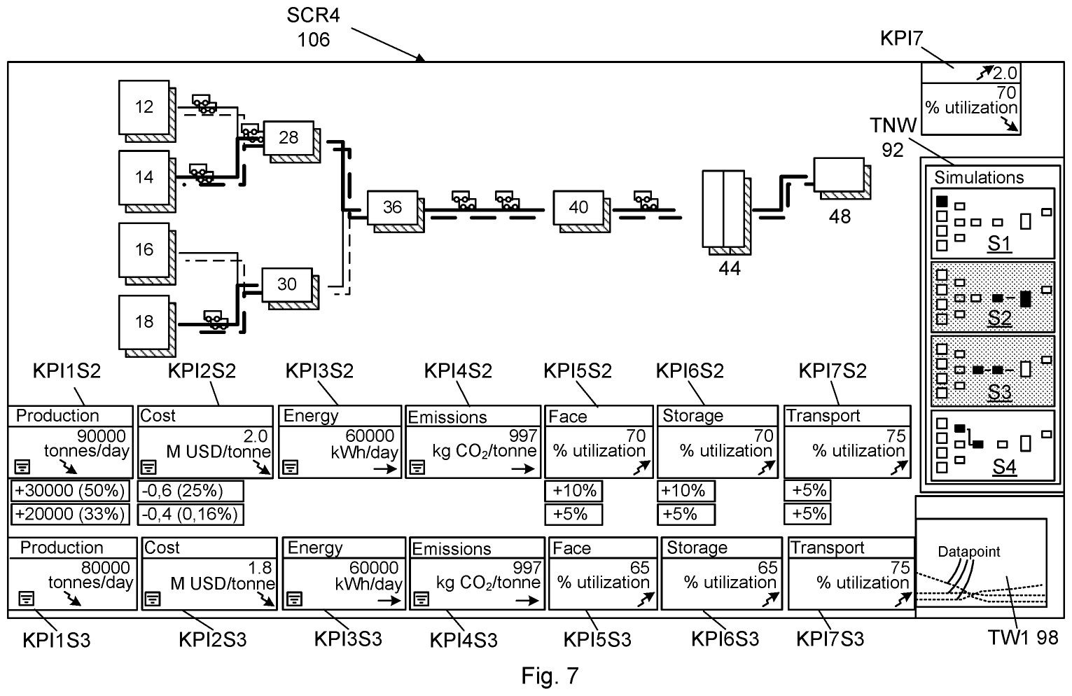

The simulation comparing device 52 therefore also provides a full-detail comparison view that can be switched to from the default comparison view. In this full-detail comparison view, the operators can see all the impacts of the simulations on the process. For each simulation, a copy of the current visualization of the process is created and enhanced by the changes resulted by the simulation. All the copies may be stacked on each other with a spatial offsetting to make them distinguishable from each other, see FIG. 7.

In the example of FIG. 7, the second simulation S2 is again the simulation of the first selection and the third simulation S3 is the simulation of the second selection. It can be seen that also the KPIs of the simulations are provided side-by-side. There is thus a first KPI of the second simulation KPI1S2, a first KPI of the third simulation KPI1S3, a second KPI of the second simulation KPI2S2, a second KPI of the third simulation KPI2S3, a third KPI of the second simulation KPI3S2, a third KPI of the third simulation KPI3S3, a fourth KPI of the second simulation KPI4S2, a fourth KPI of the third simulation KPI4S3, a fifth KPI of the second simulation KPI5S2, a fifth KPI of the third simulation KPI5S3, a sixth KPI of the second simulation KPI6S2, a sixth KPI of the third simulation KPI6S3 as well as a seventh KPI of the second simulation KPI7S2 and a seventh KPI of the third simulation KPI1S3, where the KPIs of the second simulation may be displayed in a first row below the process control elements and the KPIs of the third simulation may be shown in a row below the KPIs of the second simulation.

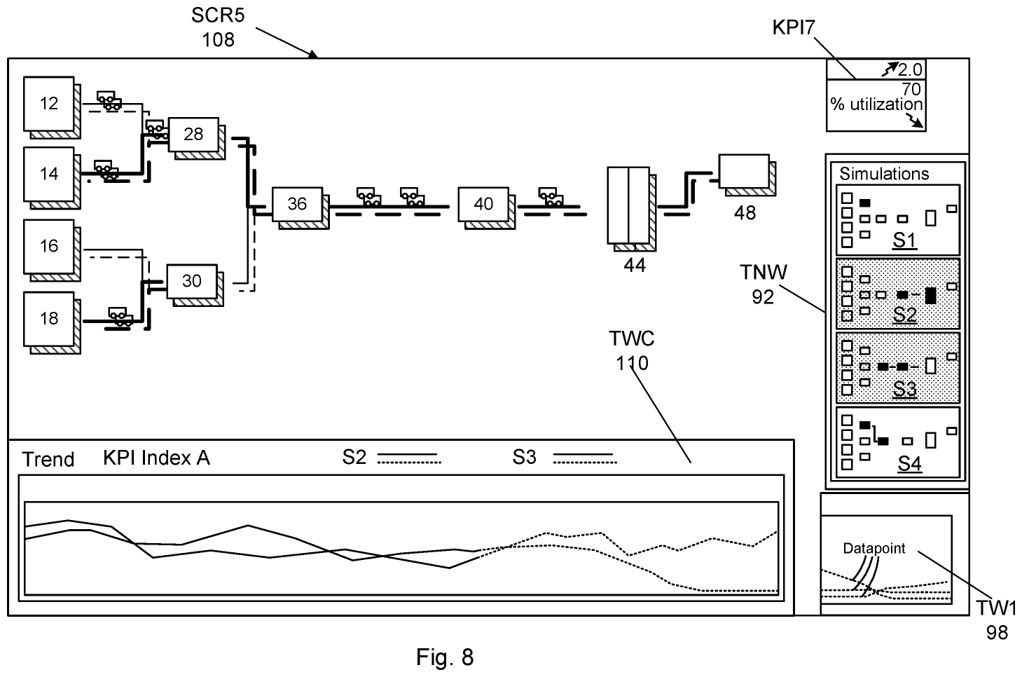

This view allows the operator to easily find details on how each simulation affects an element as well as how similarly/differently the element is affected across different control approaches. Furthermore, when operators select an element, the visual representations of that element across the selected simulated processes may be highlighted. Additional views providing further comparisons of how the selected simulations impact the element such as time-series of a certain KPIs may be also provided, see FIG. 8, where it can be seen that the trends of a KPI from both simulations S2 and S3 are shown.

For changes on the KPIs, comparative visualization approaches can be employed to emphasize side-by-side the changes different simulations caused to the KPIs. Different visual properties of an object such as sizes or colors can be utilized to visually communicate the changes to the operators this helps the operator to quickly figure out which

KPIs will remain stable and which KPIs will vary depending on the control strategies.

The operator can thereafter select the simulation that best suits a desired control objective and to apply the settings of this simulation in the control of the automation system.

It can in this way be seen that an operator may select among simulations in an efficient way where it is possible to immediately understand the pros and cons of the simulations with regard to being used in the control. Thereby the operator can quickly and coarsely identify a simulation approach and differentiate it from others. The operator can also preview the effects of the simulation on the process and efficiently compare the effects of multiple simulations on the process. This allows the operator to select parameter settings to be used in the process in a more effective way.

There are a number of variations that are possible to make. It is possible that only views for comparing two or more simulations are provided. It is additionally possible that KPIs are not shown and/or that the way that they are influenced is not shown. It is additionally possible that simulations are displayed in other ways than through thumbnails, such as through a list of names or icons.

The displaying control unit and the simulation handling unit of the simulation comparing device may be implemented using software. They may thus be implemented using computer program code, which may be provided on one or more data carriers which perform the displaying control and simulation functions when the program code thereon is being loaded into one ore more computers. One such data carrier 112 with such computer program code 58 and 60, in the form of a CD ROM disc, is schematically shown in FIG. 9. Such computer program may as an alternative be provided on a server and downloaded therefrom into the

1. A method of assisting an operator of an automation system, where the automation system implements a process flow that is displayed to the operator through a number of linked graphical objects representing elements in the process flow, the method being performed by a simulation comparing device and comprises:
obtaining current status data of a current operation of the automation system, said current status data comprising current automation system parameter settings,
receiving a first simulation selection from the operator, which first simulation selection involves a selection of a simulation with automation system parameter settings that differ from the current automation system parameter settings,
receiving a second simulation selection from the operator, which second simulation selection involves a selection of another simulation with automation system parameter settings that differ from the current automation system parameter settings and from the automation system parameter settings of the simulation selected in the first selection,
determining at least one difference in operation for the simulations of the first and the second selection, and
displaying said at least one difference in operation according to a display scheme where graphical objects corresponding to elements in the process flow that experience the difference in operation are manipulated.

2. The method according to claim 1, wherein the manipulation comprises a change in colour.

3. The method according to claim 1, further comprising determining, for each element that experiences a difference in operation, an amount with which the operation differs and the manipulating comprising manipulating the object representing the element to reflect said amount.

4. The method according to claim 3, wherein the manipulation involves varying the brightness.

5. The method according to claim 1, wherein the elements comprise paths via which the process flow occurs being represented by graphical objects in the form of lines, where the difference in operation associated with a path is displayed through varying the thickness of the line.

6. The method according to claim 1, the simulations of the first and the second selections are displayed as selectable thumbnail images in a thumbnail window.

7. The method according to claim 6, wherein each thumbnail image comprises representations of automation system elements in the process flow, where the elements that in a corresponding simulation has automation system parameter settings that differ from the current automation system parameter settings are emphasized.

8. The method according to claim 6, wherein the thumbnail images are placed in a priority order in the thumbnail window.

9. The method according to claim 1, wherein the process has a number of key performance indicators and further comprising determining the impact of each of the selected simulations on each of the key performance indicators and displaying the impact.

10. The method according to claim 1, further comprising receiving a first display mode selection from the operator, wherein in the first display mode selection the determining of at least one difference in operation includes determining a difference in operation between the simulations of the first and the second selection and the displaying of said at least one difference includes displaying one set of linked objects that is common for the selected simulations and where the display scheme is used in the display of the set of linked objects.

11. The method according to claim 1, further comprising receiving a second display mode selection from the operator, wherein in the second display mode selection the determining of at least one difference in operation includes determining a first difference in operation for the simulation of the first selection and determining a second difference in operation for the simulation of the second selection, where the first difference in operation is a difference in operation between the automation system as operated with the current automation system parameter settings and the automation system parameter settings used in the simulation of the first selection and the second difference in operation is a difference in operation between the automation system as operated with the current automation system parameter settings and the automation system parameter settings of the simulation in the second selection, and the displaying of at least one difference includes displaying the first difference in operation in a first group of graphical objects depicting the process flow using the display scheme and displaying the second difference in operation in a second group of graphical objects depicting the process flow using the display scheme and where the objects in the groups that correspond to each other are displayed together.

12. A simulation comparing device for assisting an operator of an automation system, where the automation system implements a process flow that is displayed to the operator through a number of linked graphical objects representing elements in the process flow, the simulation comparing device being configured to:
obtain current status data of a current operation of the automation system, said current status data comprising current automation system parameter settings,
receive a first simulation selection from the operator, which first simulation selection involves a selection of a simulation with automation system parameter settings that differ from the current automation system parameter settings,
receive a second simulation selection from the operator, which second simulation selection involves a selection of another simulation with automation system parameter settings that differ from the current automation system parameter and from the automation system parameter settings used in the simulation of the first selection,
determine at least one difference in operation for the simulations of the first and the second selection, and
display said at least one difference in operation according to a display scheme where graphical objects corresponding to elements in the process flow that experience the difference in operation are manipulated.

13. An automation system comprising a simulation comparing device for assisting an operator of an automation system, where an automation system implements a process flow that is displayed to the operator through a number of linked graphical objects representing elements in the process flow, the simulation comparing device being configured to:
obtain current status data of a current operation of the automation system, said current status data comprising current automation system parameter settings,
receive a first simulation selection from the operator, which first simulation selection involves a selection of a simulation with automation system parameter settings that differ from the current automation system parameter settings,
receive a second simulation selection from the operator, which second simulation selection involves a selection of another simulation with automation system parameter settings that differ from the current automation system parameter and from the automation system parameter settings used in the simulation of the first selection,
determine at least one difference in operation for the simulations of the first and the second selection, and
display said at least one difference in operation according to a display scheme where graphical objects corresponding to elements in the process flow that experience the difference in operation are manipulated.

14. A computer program for assisting an operator of an automation system, where the automation system implements a process flow that is displayed to the operator through a number of linked graphical objects representing elements in the process flow, said computer program comprising computer program code configured to cause a simulation comparing device to, when being loaded into the simulation comparing device:
obtain current status data of a current operation of the automation system, said current status data including current automation system parameter settings,
receive a first simulation selection from the operator, which first simulation selection involves a selection of a simulation with automation system parameter settings that differ from the current automation system parameter settings,
receive a second simulation selection from the operator, which second simulation selection involves a selection of another simulation with automation system parameter settings that differ from the current automation system parameter settings and from the automation system parameter settings used in the simulation of the first selection,
determine at least one difference in operation for the simulations of the first and the second selection, and
display said at least one difference in operation according to a display scheme where graphical objects corresponding to elements in the process flow that experience the difference in operation are manipulated.

15. A computer program product for assisting an operator of an automation system, said computer program product being provided on a data carrier comprising said computer program with computer program code where an automation system implements a process flow that is displayed to the operator through a number of linked graphical objects representing elements in the process flow, said computer program including computer program code configured to cause a simulation comparing device to, when being loaded into the simulation comparing device:
obtain current status data of a current operation of the automation system, said current status data including current automation system parameter settings,
receive a first simulation selection from the operator, which first simulation selection involves a selection of a simulation with automation system parameter settings that differ from the current automation system parameter settings,
receive a second simulation selection from the operator, which second simulation selection involves a selection of another simulation with automation system parameter settings that differ from the current automation system parameter settings and from the automation system parameter settings used in the simulation of the first selection,
determine at least one difference in operation for the simulations of the first and the second selection, and
display said at least one difference in operation according to a display scheme where graphical objects corresponding to elements in the process flow that experience the difference in operation are manipulated.

16. The method according to claim 2, further comprising determining, for each element that experiences a difference in operation, an amount with which the operation differs and the manipulating comprising manipulating the object representing the element to reflect said amount.

17. The method according to claim 2, wherein the elements comprise paths via which the process flow occurs being represented by graphical objects in the form of lines, where the difference in operation associated with a path is displayed through varying the thickness of the line.

18. The method according to claim 2, wherein the process has a number of key performance indicators and further comprising determining the impact of each of the selected simulations on each of the key performance indicators and displaying the impact.

19. The method according to claim 2, wherein the process has a number of key performance indicators and further comprising determining the impact of each of the selected simulations on each of the key performance indicators and displaying the impact.
